(19) United States
(12) Patent Application Publication
(10) Pub. No.: US 2025/0231142 A1
(43) Pub. Date: Jul. 17, 2025

(54) Methods and Systems for Simultaneously Generating Differential Mobility Spectrometry-Ms and -Ms/Ms Data

(71) Applicant: DH Technologies Development Pte. Ltd., Singapore (SG)

(72) Inventors: Gordana IVOSEV, Etobicoke (CA); Yves LE BLANC, Concord (CA)

(73) Assignee: DH Technologies Development Pte. Ltd., Singapore (SG)

(21) Appl. No.: 18/702,003

(22) PCT Filed: Oct. 13, 2022
(86) PCT No.: PCT/IB2022/059831

§ 371 Date: Apr. 17, 2024

Related U.S. Application Data
(60) Provisional application No. 63/256,825, filed on Oct. 18, 2021.

(51) Int. Cl. G01N 27/623; H01J 49/00

(52) U.S. Cl. CPC G01N 27/623; H01J 49/0031; H01J 49/005

(57) ABSTRACT

Methods and systems for performing differential mobility spectrometry-MS/MS are provided herein. In various aspects, methods and systems described herein can determine corresponding MS data from differential mobility spectrometry-MS/MS data obtained at each of a plurality of SV-COV combinations applied to the differential mobility spectrometry device, without requiring a separate differential mobility spectrometry-MS run, for example, each time the COV-combination is adjusted. Furthermore, the population of analyte ions, which are present in each of the plurality of product ion scans obtained at different SV-COV combinations, can be identified.

### FIELD

The present teachings generally relate to methods and systems of analyzing ions utilizing differential mobility spectrometry and mass spectrometry (MS).

### BACKGROUND

Mass spectrometry (MS) is an analytical technique for measuring the mass-to-charge ratios (m/z) of molecules within a sample, with both quantitative and qualitative applications. For example, mass spectrometry can be used to identify unknown compounds in a test substance, determine the isotopic composition of elements in a specific molecule, determine the structure of a particular compound by observing its fragmentation, and/or quantify the amount of a particular compound in a test sample. MS typically involves converting the sample molecules into ions using an ion source and separating and detecting the ionized molecules with electric and/or magnetic fields due to differences in their mass-to-charge ratios (m/z) using one or more mass analyzers. Depending on the experiment, ions generated by the ion source may be detected intact (generally referred to as MS) or alternatively may be subject to fragmentation as in tandem MS (also referred to as MS/MS or MS²) such that product ions resulting from the fragmentation of selected precursor ions may additionally or alternatively be detected.

Whereas MS typically separates ions based on their m/z at very low operating pressures (often as low as 10⁻⁵ Torr or lower), ion mobility based analytical techniques instead separate and analyze ions based upon differences in their mobility through a relatively high pressure gas. One example of such ion-mobility based techniques is differential mobility spectrometry in which a differential mobility spectrometer separates ions on the basis of an alpha parameter, which is related to the differences in the ion mobility coefficient in varying strengths of electric field. In some known differential mobility spectrometers, RF voltages, commonly referred to as separation voltages (SV) and also referred to as dispersion voltages, are applied across the drift tube in a direction perpendicular to that of the drift gas flow. Ions of a given species tend to migrate radially away from the axis of the transport chamber by a characteristic amount during each cycle of the RF waveform due to differences in mobility during the high field and low field portions. A DC potential, commonly referred to as a compensation voltage (COV or also referred to as CV), is applied to the differential mobility spectrometer and provides a counterbalancing electrostatic force to that of the SV. The COV can be tuned so as to preferentially prevent the drift of one or more species of ions of interest. Depending on the application, the COV can be set to a fixed value to pass only ion species with a particular differential mobility while the remaining species of ions drift toward the electrodes and are neutralized. Alternatively, if the COV is scanned for a fixed SV as a sample is introduced continuously into the differential mobility spectrometer, a mobility spectrum can be produced as the differential mobility spectrometer transmits ions of different differential mobilities. Examples of known differential mobility spectrometers are described in U.S. Pat. Nos. 8,084,736 and 9,835,588, the teachings of which are hereby incorporated by reference in their entireties. Differential mobility spectrometry devices that utilize curved ion paths are also known. For clarity the term, COV and CV as described are intended to refer to the same differential mobility parameter and are used interchangeably herein. Likewise, the terms separation voltage and dispersion voltage are intended to refer to the same differential mobility parameter and are used interchangeably herein.

While differential mobility spectrometry may be used on its own to analyze a sample, a differential mobility spectrometer may also be interfaced with a mass spectrometer to serve as a front end orthogonal separation method, thus taking advantage of the atmospheric pressure, gas phase, and continuous ion separation capabilities of differential mobility spectrometry to provide enhanced analytical power to the differential mobility spectrometry-MS/MS system. Such a differential mobility spectrometry-MS/MS system may enhance numerous areas of sample analysis, including proteomics, peptide/protein conformation, pharmacokinetic, metabolism analysis, trace level explosives detection, and petroleum monitoring, all by way of non-limiting example.

There remains a need for improved methods and systems for utilizing differential mobility spectrometry prior to MS/MS.

### SUMMARY

The present teachings are generally directed to improved methods and systems for differential mobility spectrometry.

In some conventional workflows utilizing differential mobility spectrometry-MS/MS, product ions resulting from the fragmentation of precursor ions transmitted by the differential mobility spectrometry at each of a plurality of SV-COV combinations are iteratively detected. However, in such conventional methods, data regarding the COV distribution of the precursor ions is typically left uncaptured. While one could, for example, utilize a differential mobility spectrometry-MS sample run at each SV-COV combination to identify the precursor ions transmitted by the differential mobility spectrometry device at the particular SV-COV combinations, such an approach would significantly increase the total analytical time for a given batch of samples. For example, when front-end liquid chromatography (LC) separation techniques are performed prior to differential mobility spectrometry-MS/MS, decreases in the duty cycle of differential mobility spectrometry-MS/MS analysis may reduce the total amount of data that can be obtained from each sample within the LC time scale.

In accordance with various aspects of the present teachings, methods and systems described herein allow for the simultaneous determination of precursor information and MS/MS data at each SV-COV combination, for example. In various aspects, the present teachings provide that MS data can be derived and/or inferred from MS/MS data obtained for each of a plurality of SV-COV combinations applied to a sample, without requiring a separate differential mobility spectrometry-MS run each time the COV is stepped, for example.

Certain aspects of the present teachings provide a method for analyzing ions, comprising determining intensities and mass-to-charge ratios (m/z) of a population of analyte ions transmitted through a differential mobility spectrometry device operating in a transmission mode in which ion mobility filtering is disabled prior to the transmitted ions being mass analyzed. For example, in transmission mode (e.g., disabled mode) for the device depicted in FIG. 1A having planar differential mobility spectrometry electrodes, the differential mobility spectrometer may be operated without a SV and COV applied thereto such that substantially all ions received from an ion source are transmitted to one or more downstream mass analyzer(s) for determining the mass spectra of the population of analyte ions. The method may also include applying a separation voltage (SV) and a compensation voltage (COV) to the differential mobility spectrometry device to enable the differential mobility spectrometry device and iteratively: (a) transmitting a plurality of ions through the enabled differential mobility spectrometry device having a SV-COV combination applied thereto so as to select a set of precursor ions based on their differential mobility; (b) fragmenting at least a portion of the set of precursor ions so as to form a set of product ions: (c) obtaining a product ion scan identifying intensities and m/z of at least a portion of the set of precursor ions; and (d) adjusting at least one of the SV and COV applied to the enabled differential mobility spectrometry device. The method may further comprise identifying which of the population of analyte ions, if any, are present in each of the plurality of product ion scans obtained at different SV-COV combinations, for example, substantially in real-time or at a later time. For a curved ion path differential mobility spectrometry device depicted in FIG. 1B operating in transmission mode, an asymmetric dispersion or separation voltage may still be applied to ensure the transmission of ions through the curved ion path, although the device can be operated without a compensation voltage.

In various aspects, identifying which of the population of analyte ions are present in each of the plurality of product ion scans obtained at different SV-COV combinations may comprise correlating the determined m/z of the population of analyte ions with the m/z of the product ion scan at each SV-COV combination.

In certain aspects, identifying which of the population of analyte ions are present in each of the plurality of product ion scans obtained at different SV-COV combinations may comprise multiplying a value indicative of the intensity at each determined m/z of the population of analyte ions by a value indicative of the intensity at each corresponding m/z of the product ion scan. In some related aspects, the value indicative of the intensity at each determined m/z of the population of analyte ions may comprise the determined intensity. Alternatively, in some related aspects, the value indicative of the intensity at each m/z of the product ion scan may be determined based relative to a threshold. For example, in certain aspects, the value indicative of the intensity at each m/z of the product ion scan may be assigned one of two binary values based on the intensity at each m/z of the product ion scan relative to the threshold.

As noted above, methods in accordance with the present teachings may include obtaining a product ion scan comprising intensities and m/z of a set of product ions for each of a plurality of SV-COV combinations. In some example aspects, obtaining the product ion scan may further comprise mass filtering the set of precursor ions transmitted through the enabled differential mobility spectrometry device to select a subset of precursor ions, and further, subjecting the subset of precursor ions to fragmentation. By way of non-limiting example, the subset of precursor ions may comprise ions of the set of precursor ions transmitted through the enabled differential mobility spectrometry device in a range of about 50 m/z or greater, which may be adjusted based on the application need. For instance, in a digest peptide analysis, the ions selected by the mass filter range could exhibit about 500 m/z or greater.

In certain aspects, the population of analyte ions and each set of precursor ions may be obtained from a liquid chromatography sample at approximately the same elution time. Additionally or alternatively, in some example aspects, the population of analyte ions and each set of precursor ions may be obtained from a liquid chromatography sample during a first elution time range in which a composition of the liquid chromatography sample is substantially identical. In some related aspects, the method may further comprise identifying which of a second population of analyte ions are present in each of a second plurality of product ion scans obtained at a plurality of SV-COV combinations from a second plurality of sets of precursor ions, wherein the second population of analyte ions and each of the second plurality of sets of precursor ions are obtained from the liquid chromatography sample during a second elution time range in which the composition of the liquid chromatography sample differs from the composition of the liquid chromatography sample during the first elution time range.

Certain aspects of the present teachings provide a system for analyzing ions, the system comprising a differential mobility spectrometry device for separating ions based on their differential mobilities and a tandem mass spectrometer for receiving ions transmitted from the differential mobility spectrometry device, the tandem mass spectrometer comprising a mass filter, a fragmentation device, and a mass analyzer. The system may also comprise a control system operatively coupled to the differential mobility spectrometry device and the tandem mass spectrometer, the control system comprising a processor and a memory including program code configured to, when executed, cause the processor to: determine intensities and mass-to-charge ratios (m/z) of a population of analyte ions transmitted through the differential mobility spectrometry device when operating in transmission or disabled mode and apply a separation voltage (SV) and a compensation voltage (COV) to the differential mobility spectrometry device to enable the differential mobility spectrometry device. The processor may also be caused to iteratively perform the following steps: (a) transmit a plurality of ions through the enabled differential mobility spectrometry device having a SV-COV combination applied thereto so as to select a set of precursor ions based on their differential mobility; (b) fragment at least a portion of the set of precursor ions so as to form a set of product ions; (c) obtain a product ion scan identifying intensities and m/z of at least a portion of the set of product ions; and (d) adjust at least one of the SV and COV applied to the enabled differential mobility spectrometry device. The processor may further be caused to identify which of the population of analyte ions, if any, are present in each of the plurality of product ion scans obtained at different SV-COV combinations.

In various aspects, when the processor is caused to identify which of the population of analyte ions are present in each of the plurality of product ion scans obtained at different SV-COV combinations, the processor is caused to correlate the determined m/z of the population of analyte ions with the m/z of the product ion scan at each SV-COV combination.

In certain aspects, when the processor is caused to identify which of the population of analyte ions are present in each of the plurality of product ion scans obtained at different SV-COV combinations, the processor is caused to multiply a value indicative of the intensity at each determined m/z of the population of analyte ions by a value indicative of the intensity at each corresponding m/z of the product ion scan. In some related aspects, the value indicative of the intensity at each determined m/z of the population of analyte ions may comprise the determined intensity. In some aspects, the value indicative of the intensity at each m/z of the product ion scan may be determined based relative to a threshold. In some related aspects, the value indicative of the intensity at each m/z of the product ion scan may be assigned one of two binary values based on the intensity at each m/z of the product ion scan relative to the threshold.

In various aspects, the at least a portion of the set of precursor ions that are fragmented may comprise a subset of precursor ions mass filtered by the mass analyzer. For example, the subset of precursor ions may comprise ions of the set of precursor ions having about 50 m/z or greater (e.g., 500 m/z or greater).

In various aspects, the population of analyte ions and each set of precursor ions may be obtained from a liquid chromatography sample at approximately the same elution time. For example, in some aspects, the population of analyte ions and each set of precursor ions may be obtained from a liquid chromatography sample during a first elution time range in which a composition of the liquid chromatography sample is substantially identical.

These and other features of the applicant's teachings are set forth herein.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1A is a schematic representation of an exemplary differential mobility spectrometer-tandem mass spectrometer system in accordance with an aspect of various embodiments of the applicant's teachings.

FIG. 1B is a schematic representation of another exemplary differential mobility spectrometer-tandem mass spectrometer system in accordance with an aspect of various embodiments of the applicant's teachings.

FIG. 2 is a block diagram that illustrates a computer system, upon which embodiments of the present teachings may be implemented in accordance with various aspects of the applicant's teachings.

FIG. 3 depicts an example method of performing differential mobility spectrometry-MS/MS in accordance with an aspect of various embodiments of the applicant's teachings.

FIG. 4 depicts another example method of performing differential mobility spectrometry-MS/MS in accordance with an aspect of various embodiments of the applicant's teachings.

FIG. 5 depicts another example method of performing differential mobility spectrometry-MS/MS in accordance with an aspect of various embodiments of the applicant's teachings.

FIGS. 6A-B schematically depict an example system and method for performing differential mobility spectrometry-MS/MS in accordance with an aspect of various embodiments of the applicant's teachings, wherein the differential mobility spectrometry device is configured to operate in transmission mode.

FIGS. 7A-D schematically depict operation of the system of FIG. 6A accordance with an aspect of various embodiments of the applicant's teachings, wherein the differential mobility spectrometry device is configured to have a first SV-COV combination applied thereto.

FIGS. 8A-D schematically depict operation of the system of FIG. 6A accordance with an aspect of various embodiments of the applicant's teaching, wherein the differential mobility spectrometry device is configured to have a second SV-COV combination applied thereto.

FIGS. 9A-D schematically depict operation of the system of FIG. 6A accordance with an aspect of various embodiments of the applicant's teachings, wherein the differential mobility spectrometry device is configured to have a third SV-COV combination applied thereto.

FIGS. 10A-D schematically depict operation of the system of FIG. 6A in accordance with an aspect of various embodiments of the applicant's teachings.

FIGS. 11A-D schematically depict operation of the system of FIG. 6A in accordance with an aspect of various embodiments of the applicant's teachings.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein mean 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

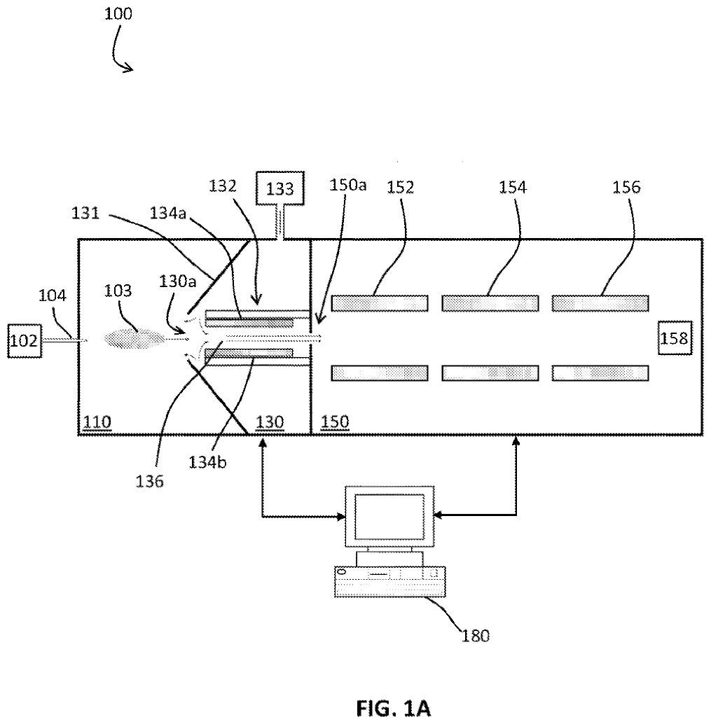

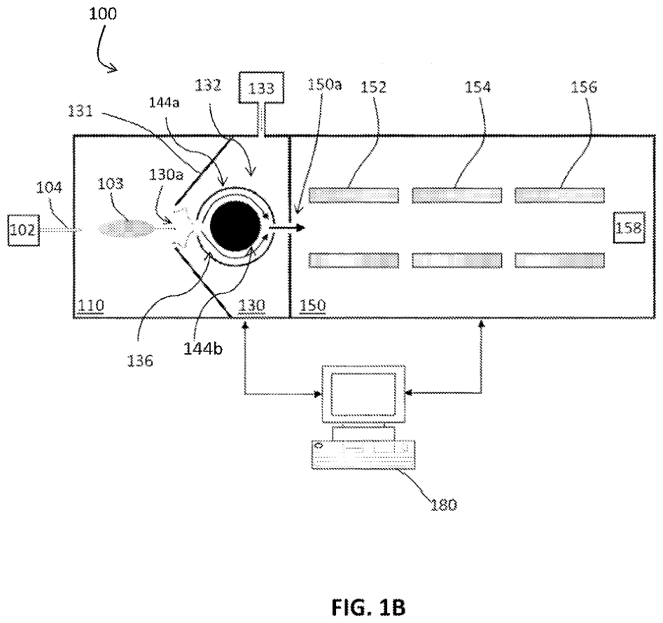

Systems and methods in accordance with various aspects of the present teachings enable the determination of precursor information (e.g., MS data) and MS/MS data for a plurality of SV-COV combinations applied to a differential mobility spectrometer, for example, without having to utilize a separate differential mobility spectrometry-MS sample run for each of the plurality of SV-COV combinations. Whereas conventional differential mobility spectrometry-MS/MS workflows fail to capture COV information associated with the precursor ions and/or require a differential mobility spectrometry-MS sample run for each SV-COV combination to identify the precursor ions transmitted for each COV, various aspects of the present teachings provide for the determination of increased MS data without substantially increasing the analytical time. In various aspects, the present teachings provide that MS data can be derived and/or inferred from MS/MS data obtained for each of a plurality of SV-COV combinations applied to a sample, without requiring a separate differential mobility spectrometry-MS run each time the COV is adjusted, for example. FIG. 1A schematically depicts an embodiment of an exemplary system 100 for performing differential mobility spectrometry-tandem mass spectrometry (differential mobility spectrometry-MS/MS) in accordance with various aspects of the applicant's teachings. As shown, the system 100 generally comprises a differential mobility spectrometry device 132 configured to receive ions from an ion source 104 and transmit at least a portion of the ions received thereby to one or more downstream chambers (e.g., vacuum chamber 150) that may house a mass filter 152, fragmentation device 154, mass analyzer 156, and detector 158 for ion processing in accordance with the present teachings. One or more power supplies (e.g., under the control of computer system 180) may be configured to apply various DC, AC, and/or RF signals to the various components of the system 100 for controlling the movement and processing of ions 103 within the system 100, as otherwise discussed herein.

In the exemplary embodiment depicted in FIG. 1A, the differential mobility spectrometry device 132 is contained within a curtain chamber 130, which is defined by a curtain plate or boundary member 131 that contains an opening 130a in communication with an ionization chamber 110. A curtain gas supply 133 is fluidly connected to the curtain chamber 130 to supply curtain gas thereto. As shown, the exemplary differential mobility spectrometry device 132 comprises a pair of opposed electrode plates 134a,b that surround a transport gas that drifts from an inlet of the differential mobility spectrometry device 132 adjacent the opening 130a to an outlet of the differential mobility spectrometry device 132 adjacent inlet 150a of the downstream vacuum chamber 150 containing one or more mass analyzers.

As indicated by the arrows of FIG. 1A, the pressure of the curtain gases in the curtain chamber 130 can provide both a curtain gas outflow out of the opening 130a, as well as a curtain gas inflow into the inlet of the differential mobility spectrometry device 132, which inflow becomes the drift gas that carries the ions 103 through the analytical gap 136 toward the inlet 150a of the vacuum chamber 150. In some aspects, a voltage can be applied to the curtain plate 131 from a suitable source to propel the ions 103 across the gap between the curtain plate 131 and the inlet end of the electrodes 134a,b. Upon entering the analytical gap 136, the ions 103 are swept along in the drift gas, and while being subjected to varying electric field generated by the parallel electrodes 134a,b to cause separation of ions based on ion mobility properties. Selected ions 103 (e.g., ions not neutralized on the electrodes 13a,b) and drift gas continue to travel down the analytical gap 132 toward inlet 150a of the vacuum chamber 150, within which the transmitted ions may be subjected to further processing.

By way of example, in certain aspects, a separation voltage (SV) and a compensation voltage (COV) can be applied to the differential mobility spectrometry device 132, when enabled, so as to perform differential mobility separation on the ions within the drift gas flowing through the analytical gap 136 between the parallel plate electrodes 134a,b. The SV, for example, may be an RF voltage signal applied to the electrodes 134a,b so as to generate an electric force across the analytical gap 136 (e.g., perpendicular to the central axis of the analytical gap 136) such that ions of various species migrate radially away from the axis of the transport chamber by a respective characteristic amount during each cycle of the RF waveform due to differences in their respective mobilities during the high field and low field portions of the RF signal. On the other hand, the COV, which may be a DC potential applied across the analytical gap 136, can provide a counterbalancing electrostatic force to that of the SV. In this manner, the COV can be tuned so as to preferentially restore a stable trajectory to particular ions such that they will traverse the entire length of the analytical gap 136 and be transmitted through inlet 150a.

The SV-COV combination may be adjusted in a variety of manners such that one or more species of ions may be transmitted from the differential mobility spectrometry device 132 into the inlet 150a as their drift therethrough does not cause them to be neutralized at the electrodes 134a,b. By way of example, in various aspects, the SV can be fixed at a value while the COV is adjusted (e.g., scanned) to serially pass ions exhibiting a particular differential mobility so as to generate a mobility spectrum. Alternatively, in some example aspects, a mobility spectrum may be generated by setting the COV to a fixed value while the SV is scanned so as to serially pass ions of interest. In some aspects, the differential mobility spectrometry device 132 may be operated with both the COV and SV fixed such that only ion species with a particular differential mobility are transmitted through from the differential mobility spectrometry device 132 while the remaining species of ions drift toward the electrodes 134a,b and are neutralized. Examples of differential mobility spectrometers which may be modified for use in accordance with the present teachings are described, for example, in U.S. Pat. Nos. 8,084,736 and 9,835,588, the teachings of which are hereby incorporated by reference in their entireties.

In various aspects, the computer system 180 may cause the differential mobility spectrometry device 132 to alternatively operate in a mode in which the differential mobility spectrometry device 132 is configured to not filter and/or not separate ions based on their differential mobilities (e.g., substantially all ions received from the ion source 104 are configured to be transmitted therethrough without being neutralized on the plates 134a,b). Such a “transmission mode” or “disabled mode” may be effectuated, for example, by the computer system 180 causing no SV or no differential DC voltages to be applied the plates 134a,b of the differential mobility spectrometry device 132 (e.g., SV=COV=0 V). It will be appreciated, for example, that when operating the differential mobility spectrometry device 132 in such a transmission mode, DC voltages applied to the electrode plates 134a,b may alternatively represent a symmetric non-zero offset value of the same polarity to the ions of interest so as to generate a substantially radially-inward force (e.g., toward the central axis) on the ions as they are transmitted between the electrode plates 134a,b.

In accordance with certain aspects of the present teachings, the curtain gas can be set to flow rates determined by a flow controller and valves so as to alter the drift time of ions within the differential mobility spectrometry device 132. Additionally, in some aspects, a throttle gas supply (not shown) can provide a throttle gas to the outlet end of the differential mobility spectrometry device 132 so as to modify the flow rate of the drift gas through the differential mobility spectrometry device 132 as described, for example, in U.S. Pat. Nos. 8,084,736, 8,513,600, and 9,171,711, all of which are incorporated herein by reference. Each of the curtain gas supply 133 and throttle gas supply (not shown) can provide the same or different pure or mixed composition gas to the curtain gas chamber. By way of non-limiting example, the curtain gas can be air, O₂, He, N₂, or CO₂. The pressure of the curtain chamber 130 can be maintained, for example, at or near atmospheric pressure (i.e., 760 Torr).

Additionally, in some aspects, the system 100 can include a chemical modifier supply (not shown) for supplying a chemical modifier and/or reagent (hereinafter referred as chemical modifier) to the curtain and throttle gases. As will be appreciated by a person skilled in the art, the modifier supply can be a reservoir of a solid, liquid, or gas through which the curtain gas is delivered to the curtain chamber 130. By way of example, the curtain gas can be bubbled through a liquid modifier supply. Alternatively, a modifier liquid or gas can be metered into the curtain gas, for example, through an LC pump, syringe pump, or other dispensing device for dispensing the modifier into the curtain gas at a known rate. For example, the modifier can be introduced using a pump so as to provide a selected concentration of the modifier in the curtain gas. The modifier supply can provide any modifier known in the art including, by way of non-limiting example, water, volatile liquid (e.g., methanol, propanol, acetonitrile, ethanol, acetone, and benzene), including alcohols, alkanes, alkenes, halogenated alkanes and alkenes, furans, esters, ethers, aromatic compounds. As will be appreciated by a person skilled in the art in light of the present teachings, the chemical modifier can interact with the ions 103 such that the ions differentially interact with the modifier (e.g., cluster via hydrogen or ionic bonding) during the high and low field portions of the SV, thereby effecting the COV needed to counterbalance a given SV. In some cases, this can increase the separation between the ion species.

The ions 103 emitted into the curtain chamber 130 via curtain chamber inlet 130a can be generated by any known or hereafter developed ion source for generating ions and modified in accordance with the present teachings. Non-limiting examples of ion sources suitable for use with the present teachings include atmospheric pressure chemical ionization (APCI) sources, electrospray ionization (ESI) sources, continuous ion source, a pulsed ion source, an inductively coupled plasma (ICP) ion source, a matrix-assisted laser desorption/ionization (MALDI) ion source, a glow discharge ion source, an electron impact ion source, a chemical ionization source, or a photo-ionization ion source, among others.

In the example depicted in FIG. 1A, the ion source 104 comprises an electrospray electrode, which can comprise a capillary fluidly coupled to a sample source 102 (e.g., through one or more conduits, channels, tubing, pipes, capillary tubes, etc.), and which terminates in an outlet end that at least partially extends into the ionization chamber 110 to discharge the liquid sample therein. As will be appreciated by a person skilled in the art in light of the present teachings, the outlet end of the electrospray electrode can atomize, aerosolize, nebulize, or otherwise discharge (e.g., spray with a nozzle) the desorption solvent into the ionization chamber 110 to form a sample plume comprising a plurality of micro-droplets generally directed toward (e.g., in the vicinity of) the curtain plate opening 130a. As is known in the art, analytes contained within the micro-droplets can be ionized (i.e., charged) by the ion source 104, for example, as the sample plume is generated. By way of non-limiting example, the outlet end of the electrospray electrode can be made of a conductive material and electrically coupled to a pole of a voltage source (not shown), while the other pole of the voltage source can be grounded. Micro-droplets contained within the sample plume can thus be charged by the voltage applied to the outlet end such that as the desorption solvent within the droplets evaporates during desolvation in the ionization chamber 110 such bare charged analyte ions are released and drawn toward the curtain plate opening 130a. One or more power supplies can supply power to the ion source 104 with appropriate voltages for ionizing the analytes in either positive ion mode (analytes in the sample are protonated, generally forming cations to be analyzed) or negative ion mode (analytes in the sample are deprotonated, generally forming anions to be analyzed). Further, the ion source 104 can be nebulizer-assisted or non-nebulizer assisted. In some embodiments, ionization can also be promoted with the use of a heater (not shown), for example, to heat the ionization chamber so as to promote dissolution of the liquid discharged from the ion source.

Additionally, as shown in FIG. 1A, the system 100 can include a sample source 102 configured to provide a sample to the ion source 104. The sample source 102 can be any suitable sample inlet system known in the art. By way of example, the ion source 102 can be configured to receive a fluid sample from a variety of sample sources, including a reservoir containing a fluid sample that is delivered to the sample source (e.g., pumped) or via an injection of a sample into a carrier liquid. In various example aspects, the sample source 102 may be a sample separation device utilizing techniques such as, but not limited to, liquid chromatography (LC), gas chromatography, or capillary electrophoresis. In some example aspects, the sample separation device may comprise an in-line liquid chromatography (LC) column, for example, that is configured to separate one or more compounds from a sample over time. In such aspects, the sample to be analyzed may be the eluent of the LC column, whose composition (and the analytes contained therein) may change over time, for example, based on binding affinity and/or the elution gradient applied to the LC column.

Although ions are depicted in FIG. 1A as exiting the differential mobility spectrometry device 132 via inlet 150a to enter the vacuum chamber 150, it will be appreciated that one or more intermediate vacuum chambers (not shown) may be disposed between the outlet of the differential mobility spectrometry device 132 and the vacuum chamber 150. Such intermediate vacuum chambers may be maintained at elevated pressures greater than the high vacuum chamber 150 within which the mass analyzers are disposed, and may contain one or more ion guides (e.g., quadrupoles) and/or ion optical elements to provide collisional cooling and/or help form an ion beam prior to delivering ions into the vacuum chamber 150. By way of non-limiting example, the ionization chamber 110 and curtain chamber 130 may be maintained at atmospheric or substantially atmospheric pressure (e.g., about 760 Torr), while the vacuum chamber 150 may be maintained at a pressure less than about 1×10⁻⁴ Torr or lower (e.g., about 5×10⁻⁵ Torr), though other pressures can be used.

FIG. 1B depicts a similar system to that of FIG. 1A, with the exception that differential mobility spectrometry device 132 is comprised of a curved ion path consisting of an outer electrode 144a and an inner electrode 144b, the space between the two defining the analytical gap 136. An asymmetric dispersion voltage or separation voltage is applied to the inner electrode 144b. The curved ion path provides a focusing effect in the presence of the asymmetric waveform that guides ions around the inner electrode 144b in the analytical gap 136. When the differential mobility spectrometry device 132 is enabled, a compensation voltage can be applied to the outer electrode to select for specific ions having specific asymmetric differential ion mobility properties. The curved ion path differential mobility spectrometry device 132 depicted in FIG. 1B operates in a transmission mode when asymmetric dispersion voltage is set to 0V and compensation voltage is set to 0V.

Ions transmitted into the vacuum chamber 150 via inlet 150a can enter the mass filter 152 (also referred to herein as Q1). As will be appreciated by a person of skill in the art, the mass filter 152 can be operated as a conventional transmission RF/DC quadrupole mass filter that can be operated to select an ion of interest and/or a range of ions of interest. For example, the computer system 180 can cause suitable RF/DC voltages to be applied to the mass filter 152 so as to operate in a mass-resolving mode. As should be appreciated, taking the physical and electrical properties of mass filter 152 into account, parameters for an applied RF and DC voltage can be selected so that mass filter 152 establishes a transmission window of chosen m/z ratios, such that these ions can traverse Q1 largely unperturbed. Ions having m/z ratios falling outside the window, however, do not attain stable trajectories within the quadrupole and can be prevented from traversing the mass filter 152. It should be appreciated that this mode of operation is but one possible mode of operation for mass filter 152. By way of example, one or more ion optical elements (not shown) between the mass filter 152 and the fragmentation device 154 can be maintained at a much higher offset potential than mass filter 152 such that Q1 can be operated as an ion trap. In such a manner, the potential applied to the ion optical elements (not shown) can be selectively lowered (e.g., mass selectively scanned) such that ions trapped in mass filter 152 can be accelerated into fragmentation device 154, which could also be operated as an ion trap, for example.

Ions transmitted by the mass filter 152 enter into the adjacent fragmentation device 154, which can be disposed in a pressurized compartment and can be configured to operate as a collision cell at a pressure approximately in the range of from about 1 mTorr to about 10 mTorr, though other pressures can be used for this or for other purposes. A suitable collision gas (e.g., nitrogen, argon, helium, etc.) can be provided by way of a gas inlet (not shown) to thermalize and/or fragment ions within the ion beam. By way of example, when in MS/MS mode, the mass filter 152 can be operated to transmit to fragmentation device 154 precursor ions exhibiting a selected range of m/z for fragmentation into product ions within fragmentation device 154. In MS mode, however, a person skilled in the art will appreciate that the parameters for RF and DC voltages applied to rods of the fragmentation device 154 can be selected so that the fragmentation device 154 transmits these ions therethrough largely unperturbed.

Ions that are transmitted by fragmentation device 154 can pass into the adjacent mass analyzer 156, which can again be operated at a decreased operating pressure relative to that of fragmentation device 154, for example, less than about 1×10⁻⁴ Torr (e.g., about 5×10⁻⁵ Torr), though other pressures can be used for this or for other purposes. As will be appreciated by a person skilled in the art, mass analyzer 156 can be operated in a number of manners, for example, as a scanning RF/DC quadrupole, as a linear ion trap, or as a RF-only ion guide to allow the ions to pass therethrough unperturbed. Indeed, suitable mass analyzer 156 for use in accordance with the present teachings include a time-of-flight (TOF) device, a quadrupole, an ion trap, a linear ion trap, an orbitrap, a magnetic four-sector mass analyzer, a hybrid quadrupole time-of-flight (Q-TOF) mass analyzer, or a Fourier transform mass analyzer, all by way of non-limiting example. In some aspects, for example, mass analyzer 156 can be operated as an ion trap for trapping ions received from the fragmentation device 154, with the potentials applied to exit ion optical elements (not shown) being selectively lowered such that ions trapped within mass analyzer 156 can be transmitted in a mass-selective manner to detector 158, which generates ion detection signals in response to the incident ions.

The computer system 180, which is in communication with the detector 158, may receive and process the ion detection signals to generate a mass spectrum of ions, for example, indicating the amount of ions (e.g., intensity, count) of each m/z that were transmitted by the mass analyzer 156.

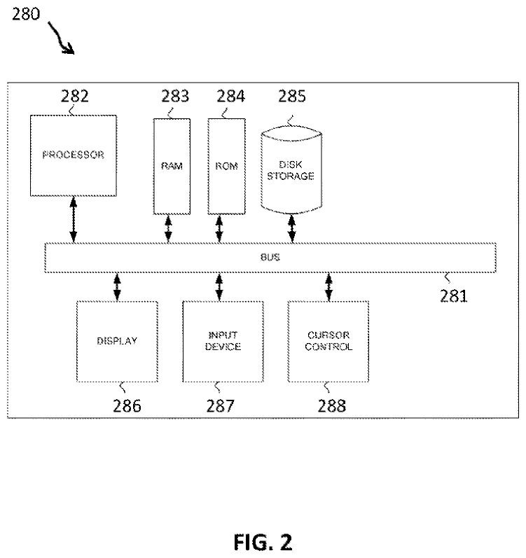

FIG. 2 is a block diagram that illustrates a computer system 280, upon which embodiments of the present teachings may be implemented. Computer system 280 includes a bus 281 or other communication mechanism for communicating information, and a processor 282 coupled with bus 281 for processing information. Computer system 280 also includes a memory 283, which can be a random access memory (RAM) or other dynamic storage device, coupled to bus 281 for storing instructions to be executed by processor 282. Memory 283 also may be used for storing temporary variables or other intermediate information during execution of instructions to be executed by processor 282. Computer system 280 further includes a read only memory (ROM) 284 or other static storage device coupled to bus 281 for storing static information and instructions for processor 282. A storage device 285, such as a magnetic disk or optical disk, is provided and coupled to bus 281 for storing information and instructions.

Computer system 280 may be coupled via bus 281 to a display 286, such as a cathode ray tube (CRT) or liquid crystal display (LCD), for displaying information to a computer user. An input device 287, including alphanumeric and other keys, is coupled to bus 622 for communicating information and command selections to processor 282. Another type of user input device is cursor control 288, such as a mouse, a trackball or cursor direction keys for communicating direction information and command selections to processor 282 and for controlling cursor movement on display 286. This input device typically has two degrees of freedom in two axes, a first axis (i.e., x) and a second axis (i.e., y), that allows the device to specify positions in a plane.

A computer system 280 can perform the present teachings. Consistent with certain implementations of the present teachings, results are provided by computer system 280 in response to processor 282 executing one or more sequences of one or more instructions contained in memory 283. Such instructions may be read into memory 283 from another computer-readable medium, such as storage device 285. Execution of the sequences of instructions contained in memory 283 causes processor 282 to perform the process described herein. Alternatively, hard-wired circuitry may be used in place of or in combination with software instructions to implement the present teachings. Thus, implementations of the present teachings are not limited to any specific combination of hardware circuitry and software. For example, the present teachings may be performed by a system that includes one or more distinct software modules for perform a method for analyzing ions in accordance with various embodiments (e.g., a differential mobility spectrometry module, a mass filter module, a fragmentation module, an analyzer module).

In various embodiments, computer system 280 can be connected to one or more other computer systems, like computer system 280, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 282 for execution. Such a medium may take many forms, including but not limited to, non-volatile media, volatile media, and transmission media. Non-volatile media includes, for example, optical or magnetic disks, such as storage device 285. Volatile media includes dynamic memory, such as memory 283. Transmission media includes coaxial cables, copper wire, and fiber optics, including the wires that comprise bus 281.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 282 for execution. For example, the instructions may initially be carried on the magnetic disk of a remote computer. The remote computer can load the instructions into its dynamic memory and send the instructions over a telephone line using a modem. A modem local to computer system 280 can receive the data on the telephone line and use an infra-red transmitter to convert the data to an infra-red signal. An infra-red detector coupled to bus 281 can receive the data carried in the infra-red signal and place the data on bus 281. Bus 281 carries the data to memory 283, from which processor 282 retrieves and executes the instructions. The instructions received by memory 283 may optionally be stored on storage device 285 either before or after execution by processor 282.

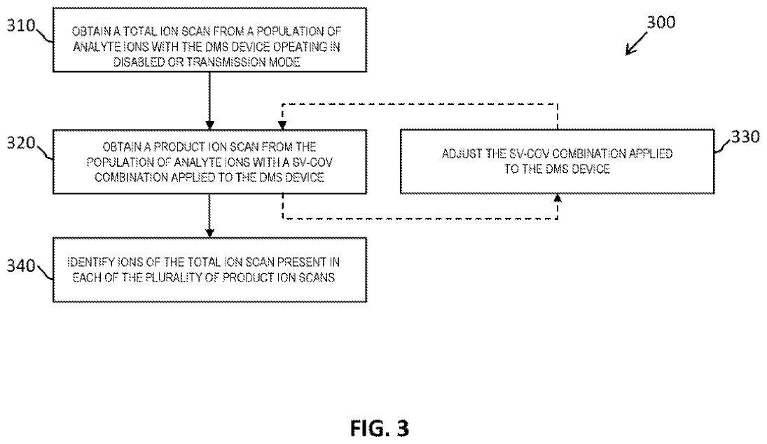

As noted above, systems and methods in accordance with various aspects of the present teachings enable the determination of MS data from MS/MS data obtained for each of a plurality of SV-COV combinations applied to a sample, without requiring a separate differential mobility spectrometry-MS run each time the combination of SV-COV is adjusted. With reference now to FIG. 3, a flowchart showing an exemplary method 300 for performing differential mobility spectrometry-MS/MS in accordance with various aspects of the present teachings is depicted. In step 310, a population of analyte ions may be transmitted through a differential mobility spectrometer (e.g., differential mobility spectrometry device 132 of FIG. 1A) while operating in transmission or disabled mode such that substantially all ions received by the differential mobility spectrometry device are configured to be transmitted therethrough (e.g., without filtering and/or separating ions based on their differential mobilities within a varying electric field). Such ions transmitted by the differential mobility spectrometry device operating in transmission or disabled mode may then be mass analyzed to identify the mass-to-charge ratios (m/z) of ions within the population as well as to determine the amount of each of ions of the various m/z. By way of example, a mass spectra of the population of analyte ions may be obtained.

Thereafter, in step 320, a first combination of SV-COV may be applied to enable the differential mobility spectrometry device to transmit at least a portion of the ions received by the differential mobility spectrometry device. By way of example, only a portion of the ions received by the differential mobility spectrometry device may exhibit a stable trajectory along the entire length of the differential mobility spectrometry device so as to be transmitted into one or more downstream elements for further processing. Such ions transmitted by the differential mobility spectrometry device are designated as first set of “precursor ions” as such ions transmitted by the differential mobility spectrometry are subjected to fragmentation conditions, for example, within fragmentation device 154 of FIG. 1A such that at least a portion of the first set of precursor ions may be fragmented. Following fragmentation, if any, ions within the fragmentation device are subjected to mass analysis (e.g., by mass analyzer 156 of FIG. 1A) and detection (e.g., by detector 158) to identify the m/z and amount of product ions generated by fragmentation. For example, a first “product ion scan” can be generated based on the ions detected by the detector as shown in step 320. Thereafter, the SV-COV combination applied to the differential mobility spectrometry device can be adjusted (step 330) and another product ion scan can be obtained at the adjusted SV-COV combination (as in step 320).

As shown in FIG. 3, after obtaining a plurality of product ion scans in the iterative steps 320/330 at a plurality of SV-COV combinations, the method can, in step 340, further comprise identifying for each of the plurality of ion scans, any ions of a particular m/z identified in the total ion scan obtained at step 310. Applicant has found, for example, that although all precursor ions transmitted into the fragmentation device are subjected to fragmentation conditions in respective steps 320, some of these precursor ions may not be fragmented such that a residual population of precursor ions may be identified from the product ion scan. In various aspects, determining whether ions present in the total ion scan are present in each of the product ion scans can comprise correlating the total ion scan with each of the product ion scans. By way of example, each m/z in the product ion scans can be compared with the corresponding m/z in the total ion scan. In various aspects, the correlation can be performed, for example, by multiplying a value indicative of the intensity at each m/z in a product ion scan by a value indicative of the intensity at each corresponding m/z in the total ion scan. It will be appreciated, for example, that if the value indicative of the intensity at a particular m/z is zero, such a multiplication with a value indicative of the intensity of the same m/z in the total ion scan will be zero. In this manner, the correlation between the total ion scan and each product ion can be effective to identify those ions of the total population of analyte ions that were transmitted at each SV-COV combination.

The total ion scan obtained with the differential mobility spectrometry device operating in transmission or disabled mode and the plurality of product ion scans operating with various SV-COV combinations applied thereto can be obtained in any order, although they are preferably obtained when the composition of the sample specimen subject to methods described herein is substantially the same. By way of example, another exemplary method 400 for performing differential mobility spectrometry-MS/MS in accordance with various aspects of the present teachings is depicted. The method 400 is similar to the method 300 discussed above, but differs in that at least one total ion scan to which the product ion scans are compared is obtained after the plurality of the product ion scans obtained at various SV-COV combinations. By way of example, a total ion scan is obtained in step 420 after at least two product ion scans have been obtained at various SV-COV combinations in step 410.

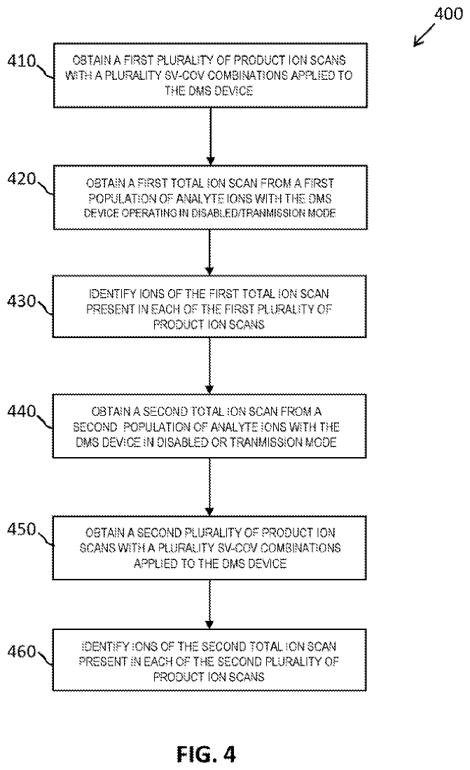

Additionally, the example method 400 depicted in FIG. 4 differs from method 300 in that a plurality of total ion scans are obtained. In particular, a total ion scan of a first population of analyte ions is obtained in step 420 and a total ion scan of a second population of analyte ions is obtained in step 440. By way of example, after a first plurality of product ion scans have been obtained in step 410 (e.g., by iteratively obtaining product ion scans and adjusting the SV-COV combination) and a first total ion scan has been obtained in step 420, the method 400 may further comprise obtaining a second total ion scan with the differential mobility spectrometry device operating in transmission or disabled mode, for example, as shown in step 440. The second total ion scan may be obtained after a pre-determined number of iterations of first product ion scans or may be obtained upon the composition of the sample specimen being changed, for example. By way of example, a second total ion scan may be obtained after a pre-determined number of iterations of first product ions scans to confirm whether the analytes in the sample specimen have changed (e.g., by comparing whether the first total ion scan and the second total ion scan exhibit ions of having substantially the same m/z and intensities). If the first and second populations of analyte ions are substantially the same, one or more additional product ion scans can be obtained as in step 410. However, if the first and second total ions scans differ, thereby indicating a different composition of the sample specimen, the method may proceed with step 450 to obtain a second plurality of product ion scans, which in step 460 can be correlated with the second total ion scan obtained in step 440.

Comparing total ion scans obtained in step 420 and step 440, each of which potentially represents a population of analyte ions from specimens of different compositions, may be especially beneficial when the ions received by the differential mobility spectrometry device are derived from a specimen of a sample separation device that is configured to separate one or more compounds from a sample over time (e.g., as with an in-line LC column). In this manner, if a comparison of the total ions scans obtained from specimens that elute at different times indicate a change in the composition of the eluent, a new set of product ion scans associated with the second specimen may be obtained. However, it will additionally be appreciated that a comparison between the first and second total ion scans is not necessary, for example, if a change in the sample composition is previously known. For example, if a user or the system has a priori knowledge of the elution profile, the timing for obtaining a first total ion scan (and the corresponding first plurality of product ion scans for comparison therewith) and for obtaining a second total ion scan (and the corresponding second plurality of product ion scans for comparison therewith) may be pre-determined.

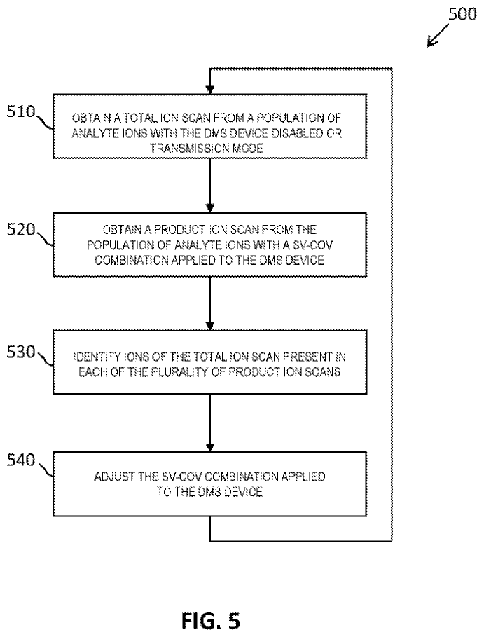

With reference now to FIG. 5, another example method 500 in accordance with various aspects of the present teachings is depicted. Method 500 is similar to method 300 of FIG. 3, but differs in that the ions present in both the total ion scan obtained in step 510 and a product ion scan 520 obtained at a particular SV-COV combination can be determined in substantially real-time. Whereas in FIG. 3, the total ion scan and product ion scans may be compared after all of the product ion scans have been obtained, the method of FIG. 5 indicates that the comparison between the total ion scan and each of the plurality of product ion scans can begin, for example, upon receiving data associated with each of the plurality of product ion scans such that the MS data for each SV-COV combination may be determined (and in some aspects displayed) in substantially real time.

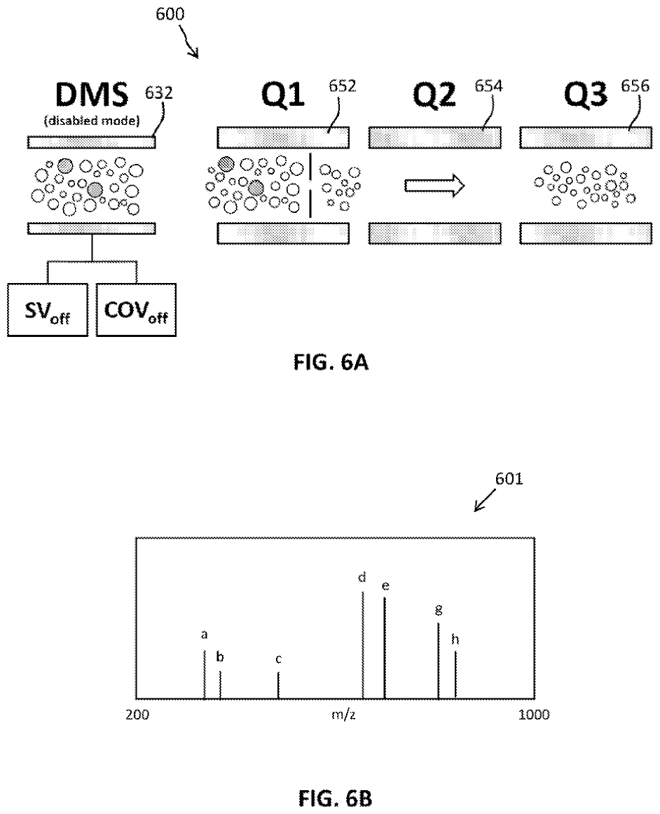

FIGS. 6-9 schematically depict another example method and system in accordance with various aspects of the present teachings. With reference first to FIGS. 6A-B, an example mass spectra 601 representing a total ion scan generated when operating the differential mobility spectrometer-tandem mass spectrometer 600 of FIG. 6A in accordance with various aspects of the present teachings is depicted. As shown schematically, the differential mobility spectrometry device 632 is operated in transmission or disabled mode by setting SV and COV equal to zero such that substantially all ions received from the ion source (not shown) are transmitted therethrough (e.g., without separating the ions based on their differential mobilities). In the depicted configuration, Q1 652 is operating as a high-pass mass filter such that only ions having 200 m/z or greater are transmitted further downstream. Such ions pass through the fragmentation device Q2 654, which may be operated so as not to promote fragmentation of the ions during their transit therethrough (e.g., as a RF-only ion guide). The ions may be trapped within mass analyzer Q3 656 and then mass-selectively scanned to a detector (not shown) to provide the m/z and intensity distribution of the ions a-h depicted in FIG. 6B (e.g., the total ion spectra 601).

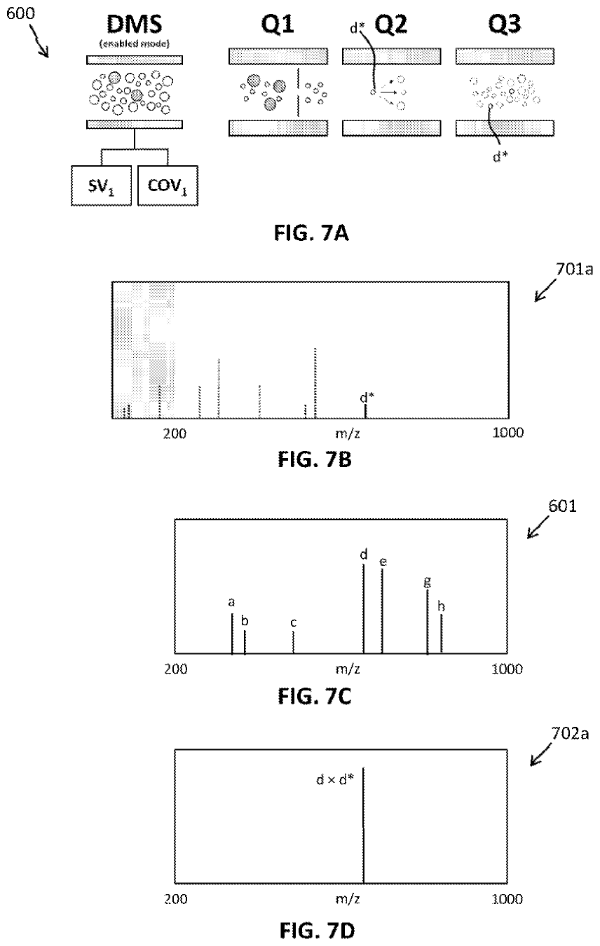

With reference now to FIGS. 7A-D, the system 600 is now configured to determine MS/MS data from the sample ions in accordance with various aspects of the present teachings. In particular, as shown in FIG. 7A, the differential mobility spectrometry device 632 is enabled by applying a separation voltage of SV₁ and a compensation voltage of COV₁ to cause separation of ions received from the ion source based on their differential mobilities. It will be appreciated that the ions depicted within the differential mobility spectrometry device 632 represent the same ions within the differential mobility spectrometry device 632 in FIG. 6A, although with the differential mobility spectrometry device 632 being enabled only a subset of these ions have been transmitted to Q1 652, which again is operating in mass filter mode such that only precursor ions having 200 m/z or greater are transmitted into Q2 654. As shown in FIG. 7A, the fragmentation device 654 is operated under fragmentation conditions as is known in the art (e.g., under high pressure, auxiliary excitation signals) so as to promote the fragmentation of ions therewithin. Ions released from the fragmentation device Q2 654 are then trapped within mass analyzer Q3 656, from which they may be again mass-selectively released. As schematically indicated in FIG. 7A, at least a portion of the ions contained within Q3 656 are residual precursor ions (d*) that were not fragmented within fragmentation device Q2 654.

FIG. 7B schematically depicts the intensities and m/z of the ions mass-selectively scanned from Q3 656 as a product ion mass spectra 701a, with the residual precursor ions (d*) being particularly identified. The product ion spectra 701a of FIG. 7B may then be correlated with the total ion spectra 601 (reproduced in FIG. 7C) to identify those ions of the product ion spectra 701a that are also present in the total ion spectra 601. As noted above, for example, the correlation can be performed by multiplying a value indicative of the intensity at each m/z in a product ion scan by a value indicative of the intensity at each corresponding m/z in the total ion scan. The total ion spectra 601 of FIG. 7D, for example, represents the detected intensity at each m/z of the product ion spectra 701a multiplied by the detected intensity at each corresponding m/z of the total ion spectra 601a. In those instances in which the intensity of a particular m/z is zero in either the total ion spectra 601 or the product ion spectra 701a, for example, the correlation will result in no peak being present at that particular m/z within the inferred MS spectra 702a at that SV₁/COV₁ combination. In particular, because only the intensity of m/z corresponding to ion d are both non-zero in FIGS. 7B and 7C, the inferred MS spectra 702a only exhibits a single peak at m/z corresponding to ion d as the product of d×d*, thereby indicating that of the ions identified in the total ion scan 601, only ion d was transmitted at the SV₁/COV₁ combination.

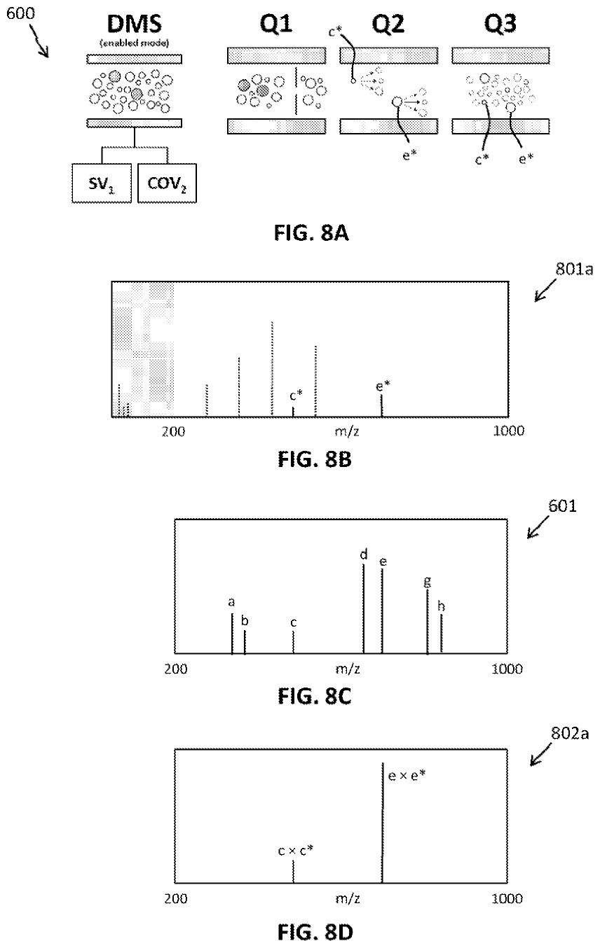

FIGS. 8A-D depict example operation of the system 600 in differential mobility spectrometry-MS/MS mode similar to FIG. 7A, but with the compensation voltage being adjusted such that the combination SV₁/COV₂ is applied to the differential mobility spectrometry device 652. FIG. 8B schematically depicts the intensities and m/z of the ions mass-selectively scanned from Q3 656 as a product ion mass spectra 801a, with the ions (c*, e*) being particularly identified. Correlating the product ion spectra 801a of FIG. 8B with the total ion spectra 601 (reproduced in FIG. 8C) results in the inferred MS spectra 802a. As shown, this correlation indicates that both ions c and e were transmitted at the SV₁/COV₂ combination.

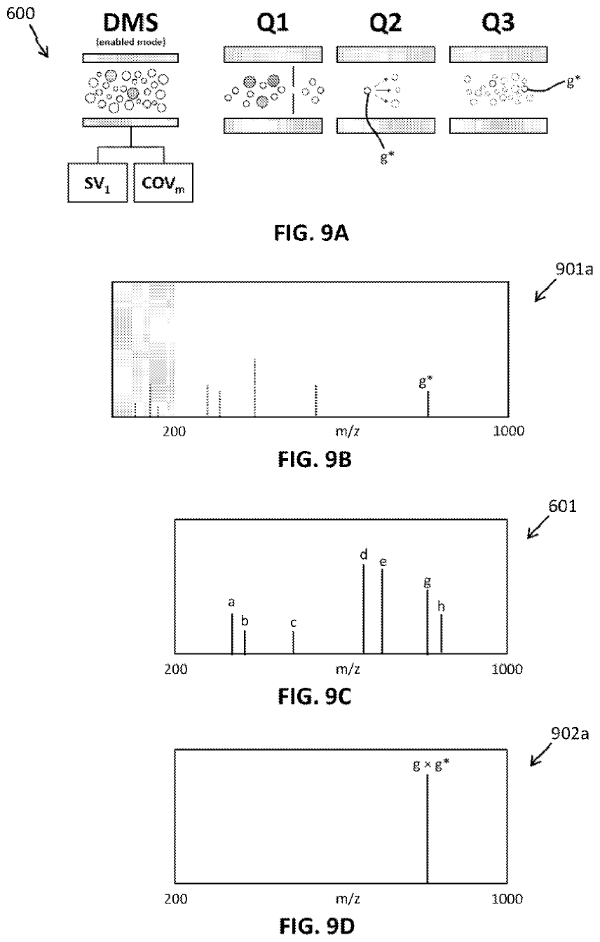

It will be appreciated that the differential mobility spectrometry conditions can be changed any number of times, for example, and product ions may be iteratively obtained at various SV-COV combinations. For example, FIGS. 9A-D depict example operation of the system 600 in differential mobility spectrometry-MS/MS mode similar to FIGS. 7A and 8A, but with the compensation voltage being again adjusted such that the combination SV₁/COVₘ is applied to the differential mobility spectrometry device 652. FIG. 9B schematically depicts the intensities and m/z of the ions mass-selectively scanned from Q3 656 as a product ion mass spectra 901a, with the ion (g*) being particularly identified. Correlating the product ion spectra 901a of FIG. 9B with the total ion spectra 601 (reproduced in FIG. 9C) results in the inferred MS spectra 902a of FIG. 9D, which present MS data indicating that only ion species g was transmitted at the particular SV₁/COVₘ combination. In this manner, certain aspects of the present teachings provide that MS data can be determined from MS/MS data obtained for each of a plurality of SV-COV combinations applied to a sample, for example, without requiring a separate differential mobility spectrometry-MS run each time the COV is stepped, for example.

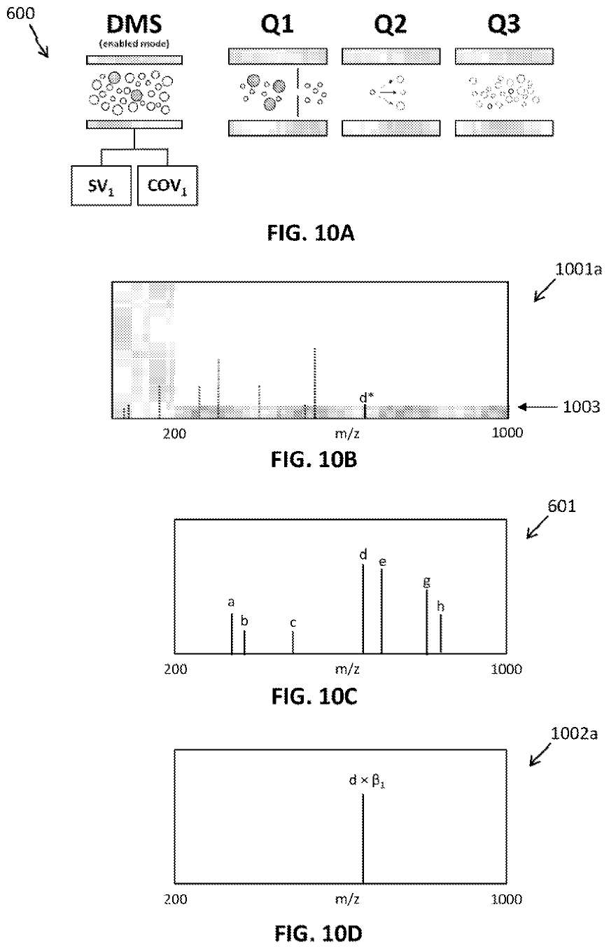

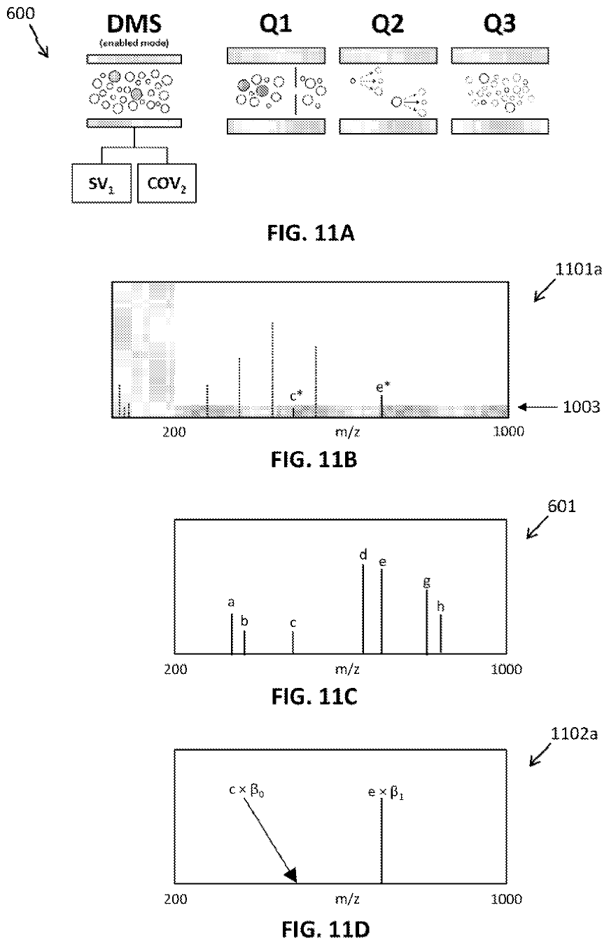

FIGS. 10-11 schematically depict another example method using the differential mobility spectrometry-tandem mass spectrometry system 600 for identifying ions present in both the total ion scan and product ion scan in accordance with various aspects of the present teachings. Whereas the correlation of FIGS. 7-9 utilized the detected intensity at each m/z in the plurality of product ion scans (as shown in FIGS. 7B, 8B, and 9B) as the values indicative of the intensity at each m/z, the present teachings that various alternative values may be used to perform the correlation. By way of example, FIGS. 10A-D depict the same differential mobility spectrometry-MS/MS conditions as FIG. 7 (e.g., a combination of SV₁/COV₁ applied to differential mobility spectrometry device 632), but differs in that the value indicative of the intensity at each m/z is determined relative to a threshold 1003. It will be appreciated by those skilled in the art that such a threshold 1003 may be selected to reduce the determination of particular ions being present in the MS data due to small, non-zero signals in the product ion spectra that may be attributed to detector noise, for example. Whereas the intensity of ion d* in the product ion spectra 1001a is above such a threshold 1003, for example, the inferred MS spectra 1002a may thus be determined as being the product of the intensity of ion d in the total ion scan (FIG. 10B) and a value β₁ as shown in the inferred MS spectra of FIG. 10D. The value β₁ may be the detected intensity of ion d* in the product ion spectra 1001a or another non-zero number (e.g., a value of 1).

Similarly, as shown in FIG. 11A-D (corresponding to the conditions of FIG. 8), the detected intensity of ion e* in the product ion scan 11B is above threshold 1003 such that the MS spectra of FIG. 11D is determined as the product of the intensity of ion e and β₁. However, because the detected intensity of ion c* in the product ion scan of FIG. 11B is below threshold 1003, the MS spectra of FIG. 11D may be determined as the product of the intensity of ion e and another value β₀. In some example aspects, if the detected intensity is non-zero but below such a threshold, the value β₀ may be selected to be zero, while the value β₁ may be selected to be 1 for ions above the threshold 1003. In this manner, the binary values indicative of the intensities of the product ions may be effective to remove from the inferred MS data ions identified in the product ion spectra as having a small, but insignificant intensity.

The descriptions herein of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software, though the present teachings may be implemented as a combination of hardware and software or in hardware alone. The present teachings may be implemented with both object-oriented and non-object-oriented programming systems.

The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

1. A method for analyzing ions comprising:
determining intensities and mass-to-charge ratios (m/z) of a population of analyte ions, wherein the population of analyte ions is transmitted through a differential mobility spectrometry device operating in transmission mode prior to being mass analyzed;
applying a separation voltage (SV) and a compensation voltage (COV) to the differential mobility spectrometry device to enable filtering mode on the differential mobility spectrometry device; and
iteratively, performing the following steps:
(a) transmitting a plurality of ions through the enabled differential mobility spectrometry device having a SV-COV combination applied thereto so as to select a set of precursor ions based on their differential mobility;
(b) fragmenting at least a portion of the set of precursor ions so as to form a set of product ions;
(c) obtaining a product ion scan identifying intensities and m/z of at least a portion of the set of product ions; and
(d) adjusting at least one of the SV and COV applied to the enabled differential mobility spectrometry device; and
identifying which of the population of analyte ions, if any, are present in each of the plurality of product ion scans obtained at different SV-COV combinations.

2. The method of claim 1, wherein identifying which of the population of analyte ions are present in each of the plurality of product ion scans obtained at different SV-COV combinations comprises correlating the determined m/z of the population of analyte ions with the m/z of the product ion scan at each SV-COV combination.

3. The method of claim 1, wherein identifying which of the population of analyte ions are present in each of the plurality of product ion scans obtained at different SV-COV combinations comprises multiplying a value indicative of the intensity at each determined m/z of the population of analyte ions by a value indicative of the intensity at each corresponding m/z of the product ion scan.

4. The method of claim 3, wherein the value indicative of the intensity at each determined m/z of the population of analyte ions comprises the determined intensity.

5. The method of claim 3, wherein the value indicative of the intensity at each m/z of the product ion scan is determined based relative to a threshold.

6. The method of claim 5, wherein the value indicative of the intensity at each m/z of the product ion scan is assigned one of two binary values based on the intensity at each m/z of the product ion scan relative to the threshold.

7. The method of claim 1, wherein obtaining the product ion scan further comprises:
mass filtering the set of precursor ions to select a subset of precursor ions; and
subjecting the subset of precursor ions to fragmentation.

8. The method of claim 7, wherein the subset of precursor ions comprises ions of the set of precursor ions having about 50 m/z or greater.

9. The method of claim 1, wherein the population of analyte ions and each set of precursor ions are obtained from a liquid chromatography sample at approximately the same elution time.

10. The method of claim 1, wherein the population of analyte ions and each set of precursor ions are obtained from a liquid chromatography sample during a first elution time range in which a composition of the liquid chromatography sample is substantially identical.

11. The method of claim 10, further comprising identifying which of a second population of analyte ions are present in each of a second plurality of product ion scans obtained at a plurality of SV-COV combinations from a second plurality of sets of precursor ions, wherein the second population of analyte ions and each of the second plurality of sets of precursor ions are obtained from the liquid chromatography sample during a second elution time range in which the composition of the liquid chromatography sample differs from the composition of the liquid chromatography sample during the first elution time range.

12. A system for analyzing ions, comprising:
a differential mobility spectrometry device for separating ions based on their differential mobilities;
a tandem mass spectrometer for receiving ions transmitted from the differential mobility spectrometry device, comprising:
a mass filter;
a fragmentation device; and
a mass analyzer;
a control system operatively coupled to the differential mobility spectrometry device and the tandem mass spectrometer, the control system comprising:
a processor;
a memory including program code configured to, when executed, cause the processor to:
determine intensities and mass-to-charge ratios (m/z) of a population of analyte ions transmitted through the differential mobility spectrometry when operating in transmission mode;
apply a separation voltage (SV) and a compensation voltage (COV) to the differential mobility spectrometry device to enable filtering on the differential mobility spectrometry device; and
iteratively, perform the following steps:
(a) transmit a plurality of ions through the enabled differential mobility spectrometry device having a SV-COV combination applied thereto so as to select a set of precursor ions based on their differential mobility;
(b) fragment at least a portion of the set of precursor ions so as to form a set of product ions;
(c) obtain a product ion scan identifying intensities and m/z of at least a portion of the set of product ions; and
(d) adjust at least one of the SV and COV applied to the enabled differential mobility spectrometry device; and
identify which of the population of analyte ions, if any, are present in each of the plurality of product ion scans obtained at different SV-COV combinations.

13. The system of claim 12, wherein when the processor is caused to identify which of the population of analyte ions are present in each of the plurality of product ion scans obtained at different SV-COV combinations, the processor is caused to correlate the determined m/z of the population of analyte ions with the m/z of the product ion scan at each SV-COV combination.

14. The system of claim 12, wherein when the processor is caused to identify which of the population of analyte ions are present in each of the plurality of product ion scans obtained at different SV-COV combinations, the processor is caused to multiply a value indicative of the intensity at each determined m/z of the population of analyte ions by a value indicative of the intensity at each corresponding m/z of the product ion scan.

15. The system of claim 14, wherein the value indicative of the intensity at each determined m/z of the population of analyte ions comprises the determined intensity.

16. The system of claim 14, wherein the value indicative of the intensity at each m/z of the product ion scan is determined relative to a threshold.

17. The system of claim 16, wherein the value indicative of the intensity at each m/z of the product ion scan is assigned one of two binary values based on the intensity at each m/z of the product ion scan relative to the threshold.

18. The system of claim 12, wherein the at least a portion of the set of precursor ions that are fragmented comprise a subset of precursor ions mass filtered by the mass analyzer.

19. The system of claim 13, wherein the subset of precursor ions comprises ions of the set of precursor ions having about 50 m/z or greater.

20. The system of claim 12, wherein the population of analyte ions and each set of precursor ions are obtained from a liquid chromatography sample at approximately the same elution time.
